(19) United States
(12) Patent Application Publication
(10) Pub. No.: US 2023/0058336 A1
(43) Pub. Date: Feb. 23, 2023

(54) KUBERNETES-BASED DYNAMIC NETWORK SERVICE CHAINING CONFIGURATION METHOD AND DEVICE

(71) Applicant: WIZONTECH CO., LTD, Seoul (KR)

(72) Inventors: Yeonjoong KIM, Seoul (KR); Yeongtae NOH, Seongnam-si (KR)

(73) Assignee: WIZONTECH CO., LTD, Seoul (KR)

(21) Appl. No.: 17/860,628

(22) Filed: Jul. 8, 2022

(30) Foreign Application Priority Data
Aug. 20, 2021 (KR) 10-2021-0110242

(51) Int. Cl. H04L 45/0377; H04L 45/00

(52) U.S. Cl. CPC H04L 45/0377; H04L 45/38

(57) ABSTRACT

A Kubernetes-based dynamic network service chaining configuration method includes: generating a virtual first provider network connected with an internal network and implemented to receive a network flow; generating a virtual second provider network connected with an external network and implemented to deliver the network flow; configuring a plurality of service chains including at least one security application between the first and second provider networks and each being independently implemented; and routing the network flow to any one of the plurality of service chains according to a predefined flow classification rule when the network flow is received through the first provider network.

### CROSS-REFERENCE TO RELATED APPLICATION

This application claims priority under 35 U.S.C. § 119 to Korean Patent Application No. 10-2021-0110242 filed on Aug. 20, 2021, in the Korean Intellectual Property Office, the disclosures of which is incorporated by reference herein in its entirety.

### BACKGROUND

The present disclosure relates to network service chaining configuration technology, and more particularly, to a Kubernetes-based dynamic network service chaining configuration method and device capable of providing a dynamic management function for a network service chain for effective application of security policies in a container-based virtualization service process.

Multi-Access Edge Computing (MEC) may move traffic and service computing from a centralized cloud to an edge of a network, bringing it closer to customers. In other words, instead of transmitting data to the cloud for processing all data, the data may be analyzed, processed and stored at the edge of the network. By collecting and processing data near customers, an MEC platform may reduce latency and provide real-time performance for high-bandwidth applications.

The MEC may also provide cloud computing functions and IT service environments at the edge of the network. In general, the MEC may be implemented through data centers distributed at the edge. Applications at the edge require high-bandwidth and low-latency environments, and to achieve the same, service providers may build distributed data centers or distributed clouds. The resources configuring the clouds may be anywhere, from centralized data centers to cell sites, central offices, aggregation sites, metro data centers, or customer premises. On the MEC platform, distributed edge computing may be performed by processing content at the edge using servers or CPE(Computer Processing Element)s.

In order to provide security for applications running on the MEC platform and the function of the security system for each tenant in the existing virtual machine environment, technology for a container environment may be required. In addition, in order to apply a security policy based on network service chaining on the container-based MEC platform, network service chaining technology may be essential.

### Related Art Document

### Patent Document

Korean Patent Application Publication No. 10-2015-0094260, Aug. 19, 2015

### SUMMARY

An embodiment of the present disclosure provides a Kubernetes-based dynamic network service chaining configuration method and device capable of providing a dynamic management function for a network service chain for effective application of security policies in a container-based virtualization service process.

An embodiment of the present disclosure provides providing a Kubernetes-based dynamic network service chaining configuration method and device capable of providing provider network generation technology to configure network service chaining, chain setting technology capable of configuring a chain of security applications, network setting technology capable of routing service based on VLAN, CLI technology capable of dynamically controlling service chain information at all times within K8S, and web service technology capable of dynamically controlling service chain information in a form of WYZWYG.

Among embodiments, a Kubernetes-based dynamic network service chaining configuration method includes: generating a virtual first provider network connected with an internal network and implemented to receive a network flow; generating a virtual second provider network connected with an external network and implemented to deliver the network flow; configuring a plurality of service chains including at least one security application between the first and second provider networks and each being independently implemented; and routing the network flow to any one of the plurality of service chains according to a predefined flow classification rule when the network flow is received through the first provider network.

The flow classification rule may be defined based on 5-tuple information in a packet header of the network flow.

The configuration of the plurality of service chains may include: configuring a network that directly connects each of the first and second provider networks and a security application; and configuring a virtual network independently connecting between security applications when the security application is formed in a plural number.

Each of the plurality of service chains may be configured such that the network flow sequentially passes through the plurality of security applications in a designated order without changing a packet header.

The configuration of the plurality of service chains may include dynamically configuring a service chain related to a container-based virtualization service through a command line interface (CLI).

The CLI may be implemented to provide functions related to (a) registration, inquiry and deletion of security application information, (b) registration, inquiry and deletion of namespace information, (c) registration, inquiry and deletion of provider network information, (d) registration, inquiry and deletion of service chain information, (e) registration, inquiry and deletion of flow classification rule information, and (f) execution and termination of a service chain.

The configuration of the plurality of service chains may include: providing a web interface implemented in the form of WysWyg through a virtual web server implemented on a master node; receiving a new service chain related to a security application input in a drag & drop method through the web interface; converting the new service chain into commands of the CLI; and applying the commands to a virtualization service cluster to add the new service chain between the first and second provider networks.

Among embodiments, a Kubernetes-based dynamic network service chaining configuration device includes: a provider network generation unit generating a virtual first provider network connected with an internal network and implemented to receive a network flow and generating a virtual second provider network connected with an external network and implemented to deliver the network flow; a service chain configuration unit configuring a plurality of service chains including at least one security application between the first and second provider networks and each being independently implemented; and a flow classification unit routing the network flow to any one of the plurality of service chains according to a predefined flow classification rule when the network flow is received through the first provider network.

Disclosed technology can have the following effects. However, it does not mean that a specific exemplary embodiment should include the entire following effects or should include only the following effects, and it should not be understood that the scope of right of disclosed technology is limited thereto.

A Kubernetes-based dynamic network service chaining configuration method and device according to an embodiment of the present disclosure is capable of providing a dynamic management function for a network service chain for effective application of security policies in a container-based virtualization service process.

The Kubernetes-based dynamic network service chaining configuration method and device according to an embodiment of the present disclosure is capable of providing provider network generation technology to configure network service chaining, chain setting technology capable of configuring a chain of security applications, network setting technology capable of routing service based on VLAN, CLI technology capable of dynamically controlling service chain information at all times within K8S, and web service technology capable of dynamically controlling service chain information in a form of WYZWYG.

### BRIEF DESCRIPTION OF THE DRAWINGS

FIG. 1 is a conceptual diagram illustrating a network service chaining configuration system according to an embodiment of the present disclosure.

FIG. 2 is a block diagram illustrating a functional configuration of the network service chaining configuration device in FIG. 1.

FIG. 3 is a flowchart illustrating a network service chaining configuration method according to an embodiment of the present disclosure.

FIG. 4 is a diagram illustrating a service chaining configuration method of a security application according to an embodiment of the present disclosure.

FIG. 5 is a diagram illustrating a multi-network service chaining method according to an embodiment of the present disclosure.

FIG. 6 is a diagram illustrating web service technology according to an embodiment of the present disclosure.

### DETAILED DESCRIPTION

Explanation of the present disclosure is merely an embodiment for structural or functional explanation, so the scope of the present disclosure should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present disclosure, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a,” “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

In each phase, reference numerals (for example, a, b, c, etc.) are used for the sake of convenience in description, and such reference numerals do not describe the order of each phase. The order of each phase may vary from the specified order, unless the context clearly indicates a specific order. In other words, each phase may take place in the same order as the specified order, may be performed substantially simultaneously, or may be performed in a reverse order.

The present disclosure may be implemented as machine-readable codes on a machine-readable medium. The machine-readable medium may include any type of recording device for storing machine-readable data. Examples of the machine-readable recording medium may include a read-only memory (ROM), a random access memory (RAM), a compact disk-read only memory (CD-ROM), a magnetic tape, a floppy disk, optical data storage, or any other appropriate type of machine-readable recording medium. The medium may also be carrier waves (e.g., Internet transmission). The computer-readable recording medium may be distributed among networked machine systems which store and execute machine-readable codes in a decentralized manner.

The terms used in the present application are merely used to describe particular embodiments, and are not intended to limit the present disclosure. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Kubernetes may be open source software supporting to deploy and manage containerized applications. Kubernetes may manage a cluster of Amazon EC2 computing instances and run containers on these instances through the processes of deployment, maintenance, and scaling. In other words, Kubernetes may be used to efficiently manage container-based virtualization functions. In addition, when Kubernetes is used, it is possible to run a desired type of containerized applications on-premises and in the cloud using the same tool set.

A Kubernetes cluster may correspond to a logical grouping of EC2 computing instances running containers. A cluster may be configured of a control plane (instances that control when, how, and where containers run) and a data plane (instances in which containers run). Accordingly, it is necessary to define a cluster before running any container or service through Kubernetes.

A Kubernetes node may correspond to a single computing instance (virtual machine) which is a part of a Kubernetes cluster. Instances may include two types: a master node and a worker node. The master node may host a Kubernetes API server and may control when, how, and where containers run. The worker node may correspond to a computing instance on which the container actually runs and processes data.

A Kubernetes Pod may correspond to a set of one or more containers, and may correspond to a method on how Kubernetes runs containers on computing instances. The pod may include information about containers and how the containers need to be run, networked, and stored. The pod may be configured of a single container, or may also be configured of multiple containers that are always running together. When the single container runs, the pod may be considered as a running container.

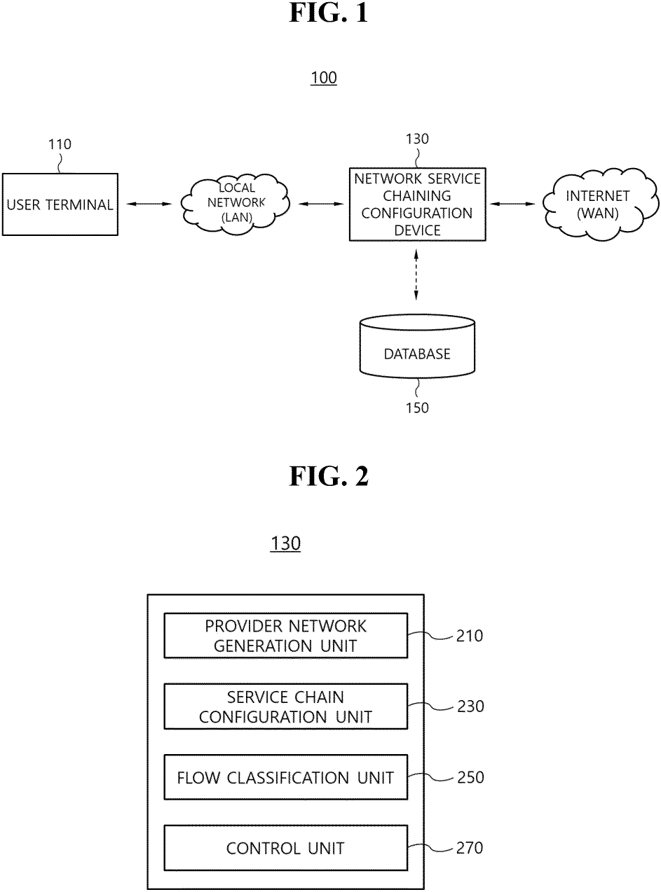

Hereinafter, a Kubernetes-based dynamic network service chaining configuration method and device according to an embodiment of the present disclosure will be described in detail with reference to FIGS. 1 to 6.

FIG. 1 is a conceptual diagram illustrating a network service chaining configuration system according to an embodiment of the present disclosure.

Referring to FIG. 1, a network service chaining configuration system 100 may include a user terminal 110, a network service chaining configuration device 130, and a database 150.

The user terminal 110 may correspond to a computing device capable of using a container-based virtualization service provided by the network service chaining configuration system 100. Here, the virtualization service may correspond to providing a cloud-based virtualized IT resource as a service, and the IT resource provided by virtualization may include a server, a platform, software, and the like.

The user terminal 110 may be implemented as a smartphone, a notebook computer, or a computer, but is not limited thereto, and may also be implemented in various devices such as a tablet PC. The user terminal 110 may be connected to the network service chaining configuration device 130 through a network (for example, LAN), and a plurality of user terminals 110 may be simultaneously connected to the network service chaining configuration device 130. In particular, the user terminal 110 may access a specific address or site by connecting to an external Internet (WAN) through the network service chaining configuration device 130, and in the process, packet transmission between both terminals may be performed through the chain of security applications provided by the network service chaining configuration device 130.

In an embodiment, the user terminal 110 may be implemented as an MEC terminal configuring a Multi-Access Edge Computing (MEC) platform. In other words, the user terminal 110 may drive the MEC platform and execute related applications, and may operate in conjunction with the network service chaining configuration device 130.

The network service chaining configuration device 130 may be implemented as a server corresponding to a computer or program capable of providing a container environment for providing security for each application and functions of a security system for each tenant of the existing virtual machine environment in the process of providing a container-based virtualization service. The network service chaining configuration device 130 may be connected to the user terminal 110 through a wired network or a wireless network such as Bluetooth or Wi-Fi, and may transmit/receive data to and from the user terminal 110 through the network. In addition, the network service chaining configuration device 130 may operate in conjunction with an external system (not shown in FIG. 1) to provide an additional function.

The database 150 may correspond to a storage device that stores various information necessary in the operation process of the network service chaining configuration device 130. The database 150 may store data related to user accounts and may store various resource information necessary for virtualization, but is not limited thereto. The network service chaining configuration device 130 may store information collected or processed in various forms while performing various dynamic network service chaining configurations. The database 150 may correspond to a logical configuration of the network service chaining configuration device 130, and in this connection, the database 150 may be implemented by being included in the network service chaining configuration device 130.

FIG. 2 is a block diagram illustrating a functional configuration of the network service chaining configuration device in FIG. 1.

Referring to FIG. 2, the network service chaining configuration device 130 may include a provider network generation unit 210, a service chain configuration unit 230, a flow classification unit 250, and a control unit 270.

The provider network generation unit 210 may perform an operation to generate and manage at least one provider network to configure network service chaining. More specifically, the provider network generation unit 210 may independently generate a first provider network connected to an internal network to receive a network flow and a second virtual provider network connected to an external network to deliver the network flow, and manage the operation thereof.

In this connection, each of the first and second provider networks may be implemented by virtualization, and may correspond to a network connected to the Internet. In other words, the provider network may configure the required virtual network infrastructure before configuring an instance, and may configure two independent provider networks for connection with an internal network and an external network by being located on each of both ends of a network service chain. The provider network may be connected to each of internal and external networks through a virtual local area network (VLAN), and may be implemented by including an L2 switch.

The service chain configuration unit 230 may configure a plurality of service chains that include at least one security application between the first and second provider networks and are each independently implemented. Here, the security application may correspond to an application that provides a network security function in a virtualization environment related to a network service chain, and various security technologies may be independently implemented. For example, the security application may include virtualized applications such as an intrusion detection system (IDS), an intrusion prevention system (IPS), and a firewall. In particular, a plurality of security applications may be configured in the form of a chain that is continuously connected and operated, and may form a service chain that provides one integrated security policy. In other words, the service chain configuration unit 230 may process an operation of configuring a plurality of security applications that form a network service chain between independent provider networks that connect internal and external networks to each other.

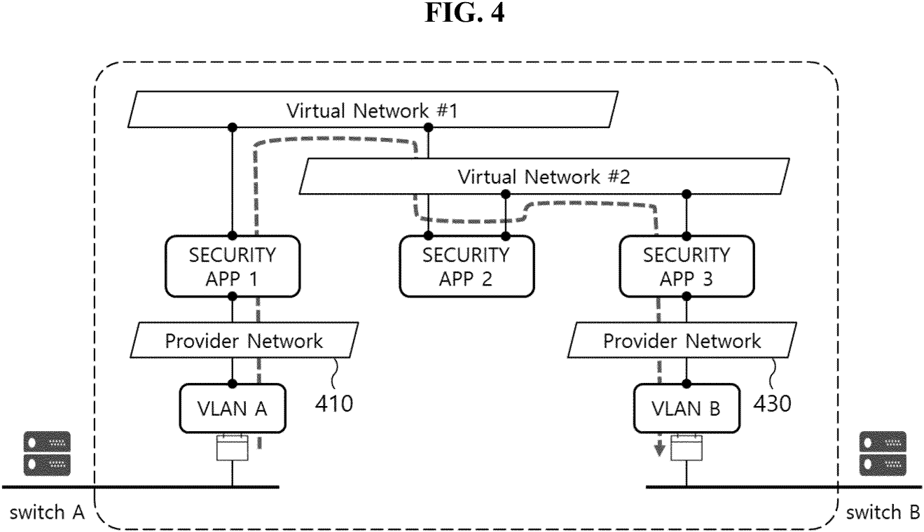

In an embodiment, the service chain configuration unit 230 may configure a network that directly connects each of the first and second provider networks and a security application, and configure a virtual network independently connecting between security applications when the security application is formed in a plural number. In this connection, each of the plurality of service chains may be configured such that the network flow sequentially passes through the plurality of security applications in a designated order without changing a packet header. Accordingly, when the network flow received through the internal network is routed to a specific service chain, it is not allowed to avoid or reversely pass through security applications of the service chain. Thus, an independent security policy may be effectively applied to a network service chain through a service chain configured of at least one security application. The same will be described in more detail with reference to FIG. 4.

In an embodiment, the service chain configuration unit 230 may dynamically configure a service chain related to a container-based virtualization service through a command line interface (CLI). Here, the CLI may be implemented to provide various functions for generation, modification, and deletion of a service chain to dynamically configure a network service chain. More specifically, the CLI may be implemented to provide functions related to (a) registration, inquiry and deletion of security application information, (b) registration, inquiry and deletion of namespace information, (c) registration, inquiry and deletion of provider network information, (d) registration, inquiry and deletion of service chain information, (e) registration, inquiry and deletion of flow classification rule information, and (f) execution and termination of a service chain.

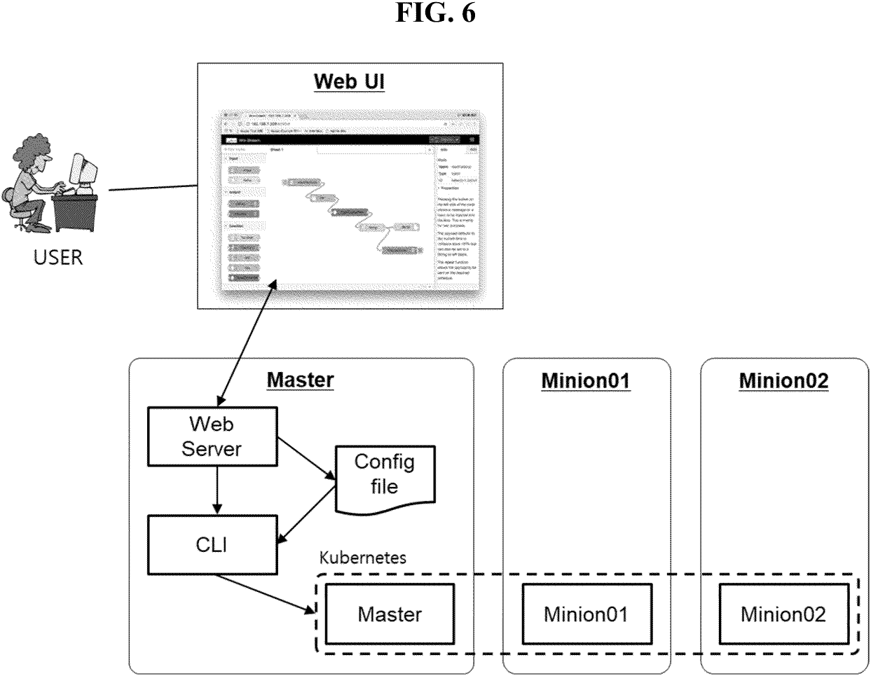

In an embodiment, the service chain configuration unit 230 may perform a plurality of phases for intuitively configuring a service chain through a convenient user interface (UI) on a web service. More specifically, the service chain configuration unit 230 may perform: providing a web interface implemented in the form of WysWyg through a virtual web server implemented on a master node; receiving a new service chain related to a security application input in a drag & drop method through the web interface; converting the new service chain into commands of the CLI; and applying the commands to a virtualization service cluster to add the new service chain between the first and second provider networks. The same will be described in more detail with reference to FIG. 6.

The flow classification unit 250 may route the network flow to any one of the plurality of service chains according to a predefined flow classification rule when the network flow is received through the first provider network. For example, the flow classification unit 250 may be implemented as a flow classifier connected to the first provider network. In other words, the first provider network may deliver the received network flow to the flow classification unit 250, and the flow classification unit 250 may select a service chain branching according to the flow classification rule based on the network flow and deliver the same to the first provider network.

Here, the flow classification rule may be defined based on 5-tuple information in a packet header of a network flow. The 5-tuple information may be included in the packet header included in the network flow, and specifically, the 5-tuple information may be defined including information about a source IP address, a source port, a destination IP address, a destination port, and a protocol.

For example, the flow classification rule may include a rule for routing a network flow having the same source IP address or destination IP address of 5-tuple information to a first service chain. In addition, the flow classification rule may include a rule for routing a network flow having the same destination IP address and destination port to a second service chain.

A network flow may be defined as a one-way traffic flow for network packets received from an internal network, and in the process of generating flow data by collecting network packets, various data formats may be applied according to the purpose of the network service chaining configuration device 130.

In an embodiment, when a network service chain is dynamically changed, the flow classification unit 250 may update a predefined flow classification rule by reflecting the changes. In other words, the flow classification unit 250 may add a classification condition for branching to the corresponding network service chain to the flow classification rule when the network service chain is added. When the network service chain is removed, a classification condition for branching to the corresponding network service chain may be removed from the flow classification rule. Registration, inquiry, and deletion of a network service chain or registration, inquiry and deletion of a flow classification rule may be performed through a function provided through the CLI.

The control unit 270 may control the overall operation of the network service chaining configuration device 130, and manage a control flow or data flow between the provider network generation unit 210, the service chain configuration unit 230, and the flow classification unit 250.

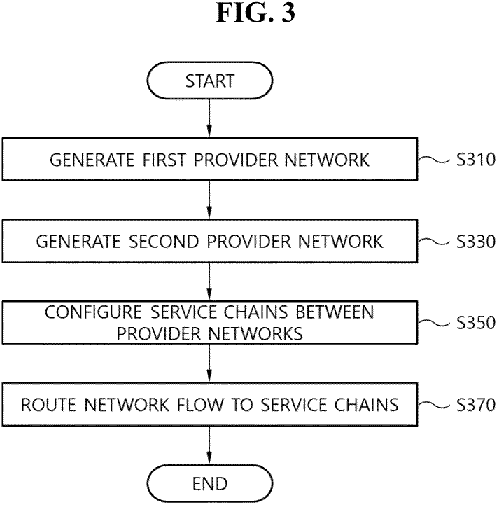

FIG. 3 is a flowchart illustrating a network service chaining configuration method according to an embodiment of the present disclosure.

Referring to FIG. 3, the network service chaining configuration device 130 may generate a virtual first provider network connected with an internal network through the provider network generation unit 210 and implemented to receive a network flow (phase S310), and generate a virtual second provider network connected with an external network and implemented to deliver the network flow (phase S330).

In addition, the network service chaining configuration device 130 may configure a plurality of service chains that include at least one security application between the first and second provider networks through the service chain configuration unit 230 and are each independently implemented (phase S350).

In addition, the network service chaining configuration device 130 may route the network flow through the flow classification unit 250 to any one of the plurality of service chains according to a predefined flow classification rule when the network flow is received through the first provider network (phase S370).

FIG. 4 is a diagram illustrating a service chaining configuration method of a security application according to an embodiment of the present disclosure.

Referring to FIG. 4, the network service chaining configuration device 130 may configure a service chain related to a security application between two provider networks configuring a network service chain. First, the network service chaining configuration device 130 may configure a virtual provider network in a container-based virtualization environment, and may configure a direct connection between the provider network and the security application. In other words, the first provider network 410 may connect VLAN A connected to an internal network with security application 1, and the second provider network 430 may connect VLAN B connected to an external network with security application 3.

In addition, security application 2 may be connected between security application 1 and security application 3 to configure one security service chain. In this connection, a virtual network may be formed between the security applications to provide a mutual connection. For example, a first virtual network (Virtual Network #1) may be configured between security application 1 and security application 2, and a second virtual network (Virtual Network #2) may be configured between security application 2 and security application 3. In other words, security application 1, security application 2, and security application 3 may be sequentially connected to form one network service chain. As a result, the network flow entering through switch A may pass through security application 1, security application 2, and security application 3 sequentially in a designated order without changing a header of a network packet, and go out through switch B (switch B).

Security applications may be managed through a separate and independent module, and may operate in conjunction with the service chain configuration unit 230. In addition, it is possible to implement various security policies applicable to the MEC platform through various application sequences and combinations for security applications and effectively apply the same to the network service chain. In addition, the network service chaining configuration device 130 may provide a web interface in the form of WysWyg to effectively configure a network service chain related to security applications.

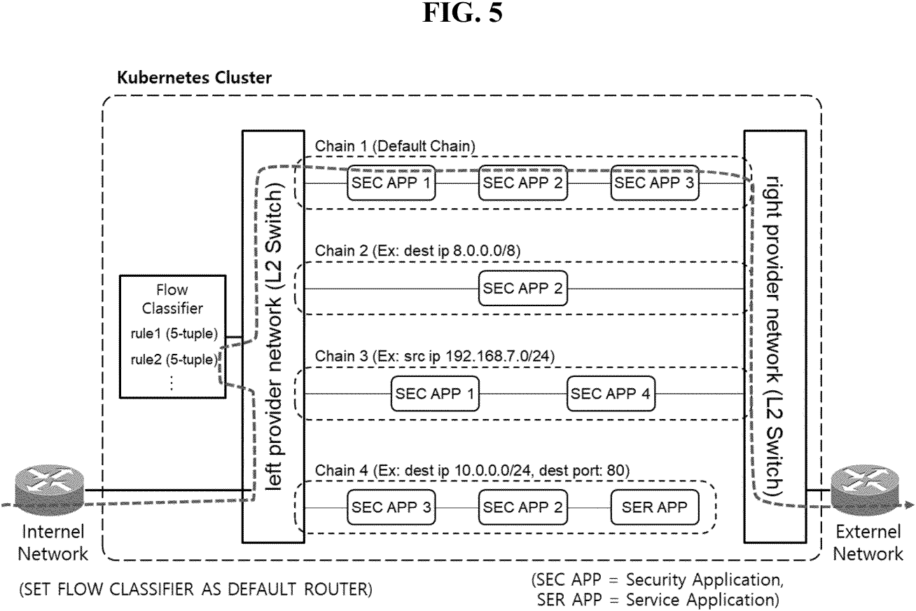

FIG. 5 is a diagram illustrating a multi-network service chaining method according to an embodiment of the present disclosure.

Referring to FIG. 5, the network service chaining configuration device 130 may generate a virtual switch (that is, a provider network) for each interface, and two different provider networks for interconnecting an internal network and an external network may be configured by virtualizing the same. In this connection, in order to provide the multi-network service chain technology, the network service chaining configuration device 130 may be implemented to include a flow classifier that interworks with the first provider network (L2 Switch).

Here, the flow classifier (iproute2) may perform an operation of sensing a 5-tuple-based network flow and routing the same to a designated service chain. In this connection, the flow classifier may perform a routing operation based on a 5-tuple-based flow classification rule (for example, rule1, rule 2, etc.). For example, the flow classification rule may set a first service chain (Chain 1) as a default chain, and may include a rule for routing to a second service chain (Chain 2) for a network flow having a destination IP (dest tip) of 8.0.0.0/8. In addition, the flow classification rule may include a rule for routing to a third service chain (Chain 3) for a network flow having a source IP (src ip) of 192.168.7.0/24, and may include a rule for routing to a fourth service chain (Chain 4) for a network flow having a destination IP (des tip) of 10.0.0.0/24 and a destination port (dest port) of 80.

In addition, a network service chain formed between two independent provider networks and implementing a predetermined security policy may be generated including at least one security application. For example, in FIG. 5, the first service chain (Chain 1) may be defined by sequentially connecting security application 1, security application 2, and security application 3, the second service chain may be configured only of security application 2, and the third service chain may be defined by sequentially connecting security application 1 and security application 4. Meanwhile, the service chain formed between the provider networks may include a security application implementing a security policy and a service application implementing an application service. The fourth service chain (Chain 4) may be configured of two security applications and one service application, and the data generated through the service application may be transmitted back to an internal network again or may be transmitted to an external network via another service chain.

FIG. 6 is a diagram illustrating web service technology according to an embodiment of the present disclosure.

Referring to FIG. 6, the network service chaining configuration device 130 may provide a web interface related to a container-based network service chain for various network service chaining configurations. In other words, the web interface (Web UI) may be implemented in the form of WysWyg, and may be implemented in a drag & drop method that allows users (or administrators) to easily set up a security application configuring a network service chain.

Accordingly, a user may select a security application configuring a network service chain through the web interface and set connection sequences and combinations in various ways. The network service chain configured through the web interface may be collected through a web server on a master node configuring a virtualization environment, and may be converted into CLI-based commands on the master node. In this connection, a configuration file may be applied in the process of being converted into the CLI-based commands. The master node may be implemented by virtualizing the network service chain by applying the CLI-based commands to a virtualization service cluster that implements the container-based virtualization service. In this connection, the virtualization service cluster may be configured of virtual images of a master node and a worker node.

More specifically, in Kubernetes, a virtualization service cluster (or a Kubernetes cluster) may be configured of a master node that forms the control plane and serves as the brain of a cluster, and worker nodes (Minion01, Minion02) that form a data plane and operate real container images through pods. The control plane may be configured of one or more API servers, distributed key/value storage, etcd, and a controller manager and a scheduler. The data plane is configured of worker nodes and may be configured by including a kubelet that performs a connection between an API server and a node, and a kube-proxy that manages IP conversion and routing.

For example, in the case of FIG. 6, a user may dispose security applications in a drag & drop method through a web service configured of a screen in the form of WysWyg, and may dynamically generate a network service chain configured of a security application by freely setting the mutual combination and connection sequence. The network service chaining configuration device 130 may convert the configuration information on the network service chain collected through the web interface into CLI-based commands and apply the same to Kubernetes clusters (Master, Minion01, Minion02).

The network service chaining configuration device 130 according to an embodiment of the present disclosure may provide technology for generating and managing a provider network to configure network service chaining in a container-based virtualization service (K8S), and may provide chain setting technology for configuring a service chain between security applications and a network setting technology for performing service routing based on VLAN.

In addition, the network service chaining configuration device 130 may be implemented by including a flow classifier that may select a service chain based on 5-tuple information (that is, source ip/port, destination ip/port, etc.), execute and manage virtual switches and applications, and provide CLI technology that may dynamically control service chain information at all times within K8S and web service technology that may dynamically control service chain information in the form of WYZWYG.

Hereinbefore, the present disclosure has been described with reference to the preferred embodiments. However, it will be appreciated by a person having ordinary skill in the pertinent technical field that various modifications and variations may be made without departing from the scope and spirit of the present disclosure as described in the following claims.

### Detailed Description of Main Elements

100: NETWORK SERVICE CHAINING CONFIGURATION SYSTEM
110: USER TERMINAL
130: NETWORK SERVICE CHAINING CONFIGURATION DEVICE
150: DATABASE
210: PROVIDER NETWORK GENERATION UNIT
230: SERVICE CHAIN CONFIGURATION UNIT
250: FLOW CLASSIFICATION UNIT
270: CONTROL UNIT

What is claimed is:

1. A Kubernetes-based dynamic network service chaining configuration method including:
generating a virtual first provider network connected with an internal network and implemented to receive a network flow;
generating a virtual second provider network connected with an external network and implemented to deliver the network flow;
configuring a plurality of service chains including at least one security application between the first and second provider networks and each being independently implemented; and
routing the network flow to any one of the plurality of service chains according to a predefined flow classification rule when the network flow is received through the first provider network,
wherein the configuration of the plurality of service chains includes:
dynamically configuring a service chain related to a container-based virtualization service through a command line interface (CLI);
providing a web interface implemented in the form of WysWyg through a virtual web server implemented on a master node;
receiving a new service chain related to a security application input in a drag & drop method through the web interface;
converting the new service chain into commands of the CLI; and
applying the commands to a virtualization service cluster to add the new service chain between the first and second provider networks.

2. The method of claim 1, wherein the flow classification rule is defined based on 5-tuple information in a packet header of the network flow.

3. The method of claim 1, wherein the configuration of the plurality of service chains includes:
configuring a network that directly connects each of the first and second provider networks and a security application; and
configuring a virtual network independently connecting between security applications when the security application is formed in a plural number.

4. The method of claim 3, wherein each of the plurality of service chains is configured such that the network flow sequentially passes through the plurality of security applications in a designated order without changing a packet header.

5. The method of claim 1, wherein the CLI is implemented to provide functions related to (a) registration, inquiry and deletion of security application information, (b) registration, inquiry and deletion of namespace information, (c) registration, inquiry and deletion of provider network information, (d) registration, inquiry and deletion of service chain information, (e) registration, inquiry and deletion of flow classification rule information, and (f) execution and termination of a service chain.

6. A Kubernetes-based dynamic network service chaining configuration device including:
a provider network generation unit generating a virtual first provider network connected with an internal network and implemented to receive a network flow and generating a virtual second provider network connected with an external network and implemented to deliver the network flow;
a service chain configuration unit configuring a plurality of service chains including at least one security application between the first and second provider networks and each being independently implemented; and
a flow classification unit routing the network flow to any one of the plurality of service chains according to a predefined flow classification rule when the network flow is received through the first provider network,
wherein the service chain configuration unit is configured to dynamically configure a service chain related to a container-based virtualization service through a command line interface (CLI), and perform:
providing a web interface implemented in the form of WysWyg through a virtual web server implemented on a master node;
receiving a new service chain related to a security application input in a drag & drop method through the web interface;
converting the new service chain into commands of the CLI; and
applying the commands to a virtualization service cluster to add the new service chain between the first and second provider networks.

7. The device of claim 1, wherein the service chain configuration unit is configured to perform:
configuring a network that directly connects each of the first and second provider networks and a security application; and
configuring a virtual network independently connecting between security applications when the security application is formed in a plural number.

8. The device of claim 7, wherein each of the plurality of service chains is configured such that the network flow sequentially passes through the plurality of security applications in a designated order without changing a packet header.
